(19) United States
(12) Patent Application Publication
(10) Pub. No.: US 2016/0222658 A1
(43) Pub. Date: Aug. 4, 2016

(54) Solid-Borne-Sound Underlay Based on a Wood-Plastics-Composite Material

(71) Applicant: Flooring Technologies Ltd., Pieta (MT)

(72) Inventors: Hendrik Hecht, Buskow (DE); Ingo Lehnhoff, Dierhagen (DE); Jens Siems, Malchin (DE)

(21) Appl. No.: 14/672,445

(22) Filed: Mar. 30, 2015

(30) Foreign Application Priority Data
Jan. 29, 2015 (DE) 20 2015 100 411.7

(51) Int. Cl. E04C 2/24; E04B 5/00; E04B 1/82; E04B 1/84; C08K 13/04; B29C 43/52; D06N 7/00; C08K 7/02; C08K 3/32; C08K 5/521; E04F 15/16; B29C 43/22

(52) U.S. Cl. CPC E04C 2/243; E04F 15/16; E04B 5/00; E04B 1/82; E04B 1/8409; B29C 43/22; B29C 43/52; D06N 7/00; C08K 7/02; C08K 3/32; C08K 5/521; C08K 13/04; B29K 2101/12

(57) ABSTRACT

A solid-borne-sound underlay based on a wood-plastics-composite material. A process for production of the solid-borne-sound underlay is also provided. The process involves the step of applying a mixture of wood particles and plastic particles to at least one first conveyor belt with formation of a preliminary web and introduction of the preliminary web into at least one first continuous-flow oven. The process also involves the step of transfer of precompacted preliminary web into at least one twin belt press. The process also involves the step of cooling compacted solid-borne-sound underlay made of wood-plastics-composite material in at least one cooling press.

### BACKGROUND OF THE INVENTION

1. Field of the Invention

The present invention relates to a solid-borne-sound underlay based on wood-plastics-composite material.

2. Description of Related Art

Walking on hard-surface floorcoverings, e.g. laminate, often produces loud noises which, within an indoor space, are perceived as undesirable. The term walking noise or room noise is used for these noises. Walking on hard floors, for example laminate, produces what is known as solid-borne sound, which is perceived as undesirable in the rooms below. Attenuation of this solid-borne sound is especially necessary in multistory dwellings. Walking noise and solid-borne sound are primarily influenced by the solid-borne-sound underlay of the relevant floorcovering. Some available laminate floors and parquet floors therefore already have an integrated insulating underlay. However, most hard floorcoverings do not have any insulating layer bonded thereto. Any undesirable noise arising here can be mitigated by using products from the field of insulating foils and solid-borne-sound insulation. By using foils and solid-borne-sound insulation it is often possible to halve the sound levels (about 5-6 dB).

Especially for laminate floors using a click-lock laying system, it is advisable to use a pressure-resistant underlay. This can avoid possible damage in the tongue-and-groove region due to heavy objects. Compressive strength of at least 2 t/cubic meter is recommended.

Walking on hard floorcoverings can be less pleasant because of the nature of their surface. The feeling experienced during walking can be improved by using a resilient solid-borne-sound underlay. In the case of floors using very hard insulating materials it is advisable to use a specific compensating underlay.

Foils and underlay webs not only have insulating properties in respect of solid-borne sound and walking noise but are also capable of compensating any minor unevenness of the substrate. The most suitable solid-borne-sound underlays are those that moreover have high compressive strength.

Insulating materials are available currently in various thicknesses with or without integrated moisture protection. Thin insulating materials are especially suitable when available installation height is small; thicker materials have good thermal-insulation properties and are suitable by way of example for the leveling of old woodstrip floors.

Some solid-borne-sound underlays can be laid on an electrical floor-heating system. In the case of hot-water floor-heating systems it is necessary to lay a PE foil in addition to the solid-borne-sound underlay (unless the solid-borne-sound underlay already has an integrated vapor barrier). Care also has to be taken that the heat transmission resistance of the floor system (floor and insulating underlay) does not exceed 0.15 m²K/W; otherwise the heating performance of a hot-water floor-heating system would be impaired.

The solid-borne-sound underlays used in the floorcovering sector therefore have to comply with a very wide variety of requirements. Firstly they are intended to reduce solid-borne-sound or room noise, but at the same time they are intended to provide other functions such as thermal insulation. In extreme cases the solid-borne-sound underlays are also intended to be suitable for use in conjunction with a floor-heating system.

Solid-borne-sound underlays used currently are composed by way of example of pressed wood fibers or simply of plastics, for example extruded polystyrene foam, rigid polystyrene foam, or polyethylene foam. None of the products available currently in the field of solid-borne-sound underlays can by itself comply with the abovementioned requirements. Achievement of good thermal insulation by way of example requires that conventional solid-borne-sound underlays have high thicknesses, and this restricts the usefulness of these solid-borne-sound underlays when only low floor-system heights are permissible because of the preconditions imposed by the nature of the building. Only a few of the conventional solid-borne-sound underlays can be used in areas where floor-heating systems are present.

As mentioned above, some of the conventional solid-borne-sound underlays are based on pressed wood fibers. A particular problem with the use of the wood-fiber insulation materials mentioned is that these are not elastic and therefore cannot be rolled up. This leads to disadvantages during transport and storage, and especially during laying of the conventional solid-borne-sound underlays based on pressed wood fibers.

An alternative to the use of solid-borne-sound underlays with the elasticity problem mentioned is provided by conventional solid-borne-sound underlays made of plastics, for example polystyrene foam or polyethylene foam, which are available and can also be obtained in roll form. However, a disadvantage with the use of solid-borne-sound underlays made of plastics is that these have poorer thermal insulation properties than, for example, wood-based materials; greater thicknesses are therefore required for these solid-borne-sound underlays, and there can be a resultant disadvantageous effect in respect of the permissible installation heights of the floorcoverings.

The technical object underlying the present invention is therefore to eliminate the disadvantages described and to provide solid-borne-sound underlays with relatively low thickness, improved compressive strength, and improved elasticity in variable formats which can also be rolled up reversibly. These solid-borne-sound underlays are intended then to be used as underlays for floor systems, and are in particular suitable for use when available installation height is small.

### SUMMARY OF THE INVENTION

Accordingly, a solid-borne-sound underlay is provided, in particular based on a wood-plastics-composite material.

The process for the production of a solid-borne-sound underlay of the invention, in particular in the form of a wood-plastics material, comprises the following steps:
application of a mixture of wood particles and plastic to at least one first conveyor belt with formation of a preliminary web and introduction of the preliminary web into at least one first continuous-flow oven for precompaction;
transfer of the precompacted preliminary web into at least one twin-belt press for further compaction to give a solid-borne-sound underlay made of a wood-plastics-composite material; and
cooling of the compacted solid-borne-sound underlay made of a wood-plastics-composite material in at least one cooling press.

### DETAILED DESCRIPTION OF THE INVENTION

Accordingly, a multistage process, in particular a three-stage process, is provided in which firstly a preliminary web or, respectively, an attenuating-material mat with low envelope density is provided from a mixture of wood particles, e.g. in the form of wood fibers, and plastics, in particular thermoplastics. This preliminary web or, respectively, attenuating-material mat with low envelope density is then firstly compacted in a twin-belt press under high pressure and at high temperature, and is then cooled in a cooling press. The present process permits the production of solid-borne-sound underlays made of wood-plastics-composite materials in large formats which are suitable for use as solid-borne-sound underlays by way of example for laminate floors, with high productivity and therefore relatively low costs.

In one embodiment of the present invention, a thermoplastic, in particular in the form of thermoplastic granules or synthetic fibers, is used in the wood-particle-plastics mixture.

The thermoplastic is preferably selected from a group comprising polyethylene (PE), polypropylene (PP), polyvinyl chloride (PVC), polyester, polyethylene terephthalate (PET), polyamide (PA), polystyrene (PS), acrylonitrile-butadiene-styrene (ABS), polymethyl methacrylate (PMMA), polycarbonate (PC), polyether ether ketone (PEEK), polyisobutylene (PIB), polybutylene (PB), and mixtures and copolymers thereof. In particular it is preferable to use, as thermoplastic, PE, PP, PVC, or a mixture thereof.

As mentioned above, the thermoplastic can be used in the form of synthetic fibers. The synthetic fibers here can take the form of monocomponent fibers or of bicomponent fibers. The heat-activatable synthetic fibers or, respectively, binder fibers have not only a binder function but also a supportive function in the matrix made of wood fibers and, respectively, wood particles. If monocomponent fibers are used, these are preferably composed of polyethylene or of other thermoplastics with low melting point.

It is particularly preferable to use bicomponent fibers. Bicomponent fibers increase the stiffness of wood-fiber sheets and also reduce the tendency toward creep that can be encountered in thermoplastics (e.g. PVC laminates).

The bicomponent fibers are typically composed of a carrier filament or else a core fiber made of a plastic with relatively high resistance to temperature change, in particular polyester or polypropylene, these being coated or sheathed by a plastic with a relatively low melting point, in particular made of polyethylene. After melting or incipient melting, the coating or the sheath of the bicomponent fibers allows crosslinking between the wood particles. Bicomponent fibers in particular used here are those based on thermoplastics such as PP/PE, polyester/PE, or polyester/polyester. It is very particularly preferable to use bicomponent fibers based on PE.

In another embodiment of the present invention, a wood-particle-plastics mixture, in particular wood-fiber-synthetic-fiber mixture, is used which comprises a ratio between 90% by weight of wood particles: 10% by weight of plastic and 20% by weight of wood particles: 80% by weight of plastic, preferably between 70% by weight of wood particles: 30% by weight of plastic and 40% by weight of wood particles: 60% by weight of plastic. The wood-particle-plastics mixture used can by way of example have 75% by weight of wood fibers and, respectively, wood particles, and 18% by weight of bicomponent fibers, e.g. polyethylene terephthalate/polyethylene terephthalate-co-isophthalate fibers or PP/PE fibers.

It is equally conceivable that the plastics content itself is a mixture of various plastics: a plastics mixture can be composed of 20% by weight of bicomponent fibers: 80% by weight of PE fibers up to 80% by weight of bicomponent fibers: 20% by weight of PE fibers. It is generally also possible to use other compositions. By varying the composition of the plastics component it is possible to alter, and appropriately modify, the temperature required for the compaction of the web.

These modified wood particles are defined as being lignocellulose-containing comminution products such as wood fibers, woodchips, or else wood flour made of timber from coniferous and/or deciduous trees. When wood fibers are used, it is in particular possible to use dry wood fibers of length from 1.0 mm to 20 mm, preferably from 1.5 mm to 10 mm, and of thickness from 0.05 mm to 1 mm. The moisture level of the wood fibers used here is in the range between 5 and 15%, preferably 6 and 12%, based on the total weight of the wood fibers.

It is equally possible to define the wood particles used with reference to the median particle diameter, where the median particle diameter d50 can be between 0.05 mm and 1 mm, preferably 0.1 and 0.8 mm.

In accordance with the desired composition of the wood-particle-plastics mixture, the individual components (wood particles and plastic) are mixed intimately in a mixer. The mixing of the components can be achieved by way of example by charging to a blowing line. Between the charging of the components and the holding vessel here, the air injected as means of transport provides intimate mixing. The intimate mixing of the components is further advanced in the holding vessel by virtue of the transport air injected.

From the holding vessel, the wood-particle-plastics mixture is, for example after weighing-out on a large-area balance, blown uniformly over the width of a first conveyor belt. The quantity of wood-particle-plastics mixture supplied depends on the desired layer thickness and the desired envelope density of the preliminary web to be produced. Typical weights per unit area of the scattered preliminary web here can be in the range between 3000 and 10 000 g/m², preferably between 5000 and 7000 g/m². As already mentioned, the width of the scattered preliminary web is defined via the width of the first conveyor belt and can by way of example be in the range up to 3000 mm, preferably 2800 mm, with particular preference up to 2500 mm.

In one preferred embodiment of the invention, the process for the production of the solid-borne-sound underlay of the invention based on a wood-plastics-composite material is in particular one wherein the wood fibers and the synthetic fibers are introduced from bale openers uniformly in the desired mixing ratio into a blowing line by way of separate weighing equipment downstream of the bale openers, and are supplied pneumatically via the blowing line to a holding vessel from which the fiber mixture is blown onto a first conveyor belt with spatial orientation of the fiber, the resultant web is defibrated at the end of the first conveyor belt, and after remixing is blown onto a second conveyor belt with spatial orientation of the fibers, where the thickness of the resultant mat is established via the speed of revolution of the second conveyor belt, the resultant product is transferred to an oven belt, and on this is passed through the continuous-flow/cooling oven where the softening of the synthetic fibers, and thus intimate adhesive bonding of the wood fibers, is achieved, as also is the final thickness of the solid-borne-sound underlay, via calibration and/or compaction.

In the invention, the process provides three-dimensional orientation to the fibers used. This orientation of the fibers is maintained until final consolidation occurs. Devices preferably used for the conduct of the process are those of the type known for the production of textiles by the nonwoven process. The moisture level of the wood fibers used for the production of the solid-borne-sound underlay of the invention is between 7 and 16%, in particular 12 and 14%.

Each of the input bales of wood fibers and binder fibers is supplied to a bale opener, which provides effective opening of the fibers.

In accordance with the desired composition, the individual components are weighed-out by way of separate weighing equipment arranged downstream of the respective bale openers, and are passed into a blowing line. Between the charging of the components and the holding vessel here, the air injected as means of transport provides intimate mixing. The fine synthetic fibers achieve good contact here with the wood fibers, which are present in excess.

The intimate mixing of the fibers is further advanced in the holding vessel by virtue of the transport air injected. From the holding vessel, the wood-fiber-plastics mixture is weighed out on a large-area balance and then blown uniformly over the width of a first conveyor belt. The quantity of fiber mixture supplied depends on the desired layer thickness and on the desired envelope density of the solid-borne-sound underlay to be produced, where the envelope densities are between 20 and 300 kg/m³. The fibers in the resultant preliminary web have three-dimensional orientation.

At the end of the first conveyor belt, the preliminary web passes into a defiberizing device, where again the fibers used are mixed. The resultant fiber mixture is blown onto a second conveyor belt, and three-dimensional orientation of the fibers is provided.

The layer thickness of the resultant continuous mat is established via control of the speed of revolution of the second conveyor belt.

After application of the wood-particle-plastics mixture to the second conveyor belt, with formation of a mat, the mat is passed into at least one first continuous-flow oven for precompaction, and hot air is passed through the system. In one particularly preferred embodiment of the process, the preliminary web made of wood particles and plastic is heated in the at least one continuous-flow oven to a temperature which is equal or above the melting point of the plastic used.

The temperatures in the continuous-flow oven can be between 125 and 150° C., preferably 130 and 145° C., with particular preference 135 and 140° C. The core temperature of the preliminary web is preferably about 140° C. During heating in the continuous-flow oven, incipient melting of the plastics material takes place, thus producing an intimate bond between the plastics material, e.g. the synthetic fibers, and the wood fibers, while simultaneously achieving compaction of the preliminary web.

The temperatures in the continuous-flow oven are maintained by way of example via injection of hot air.

In another embodiment of the present process, the envelope density of the precompacted mat after discharge from the continuous-flow oven is between 40 and 200 kg/m³, preferably 60 and 150 kg/m³, with particular preference between 80 and 120 kg/m³. The thickness of the precompacted mat here can be between 5 and 40 mm, preferably 5 and 20 mm, with particular preference 10 mm.

In particular it is preferable that the advance rate of the conveyor belt in the continuous-flow oven is in the range between 5 and 15 m/min, preferably between 6 and 12 m/min.

After discharge from the continuous-flow oven, the precompacted mat can be cooled and cut to size. Typical measures for cutting to size are by way of example the edge-trimming of the mat. The resultant waste, in particular the resultant edge strips, can be comminuted and returned to the process. The material can be fed directly into the receiving container, because it comprises the desired mixing ratio.

In a further step of the present process, the precompacted mat is compacted in at least one twin-belt press to a thickness between 2 and 15 mm, preferably 2 and 9 mm, with particular preference to 2.5 mm.

The temperature applied during the compaction of the preliminary web in the at least one twin-belt press is between 140 and 200° C., preferably 140 and 180° C., particularly preferably 140 and 160° C., with particular preference 150° C. The pressure used in the at least one twin-belt press can be between 2 MPa and 10 MPa, preferably 3 MPa and 8 MPa, with particular preference 5 and 7 MPa. The advance rate of the twin-belt press is between 5 and 15 m/min, preferably between 6 and 12 m/min.

After discharge from the at least one twin-belt press, the compacted mat discharged from the twin-belt press is passed into at least one cooling press in which the compacted mat is cooled to temperatures between 10 and 100° C., preferably 15 and 70° C., with particular preference 20 and 40° C. The pressure used here in the at least one cooling press is identical, or at least almost identical, with the pressure in the twin-belt press, i.e. the pressure prevailing in the cooling press is between 2 MPa and 10 MPa, preferably 3 MPa and 8 MPa, with particular preference 5 and 7 MPa.

The fibers in the solid-borne-sound underlay of the invention are present in a three-dimensionally crosslinked synthetic-fiber structure where adhesion points are present not only between the synthetic fibers but also between synthetic fibers and wood fibers. It is necessary to pass the compacted mat into a cooling press because the recovery forces of the fibers can be so great that, without the cooling-press step, the mat would deconsolidate after compaction in the twin-belt press.

The envelope density of the compacted mats after discharge from the cooling press is in the range between 200 and 400 kg/m³, preferably between 220 and 300 kg/m³, with particular preference 260 kg/m³.

In another embodiment of the present invention it has proven to be advantageous that the solid-borne-sound underlay comprises other substances such as fillers or additives. These fillers or additives are preferably added to the wood-particle-plastics mixture before compaction, and provide specific properties to the solid-borne-sound underlay of the invention.

Suitable additives that can be present in the present solid-borne-sound underlay are flame retardants or antibacterial substances. Suitable flame retardants can be selected from the group comprising nitrogen, phosphates, borates, in particular ammonium polyphosphate, tris(tribromoneopentyl) phosphate, zinc borate, and boric acid complexes of polyhydric alcohols. It is preferable that the proportion of the flame retardants in the present solid-borne-sound underlay is between 5 and 10% by weight, particularly between 6 and 8% by weight, with particular preference 7% by weight.

The solid-borne-sound underlay of the invention has a plurality of advantages. Its thickness is less than that of conventional solid-borne-sound underlays. The solid-borne-sound underlay of the invention has very high compressive strength. Surprisingly, the elasticity of the solid-borne-sound underlay of the invention is sufficient to allow the mat to be rolled up reversibly. The solid-borne-sound underlay of the invention is therefore easier to transport and easier to lay, and is more versatile. It is effective in reducing solid-borne-sound and room noise for all laminate floors and engineered parquet floors. High frequencies are shifted to darker frequencies that are more acceptable to the human ear. Increased pressure resistance is moreover combined with extremely elastic behavior of the underlay. The solid-borne-sound underlay of the invention moreover improves solid-borne-sound insulation. Undesirable noise in residential units below is greatly reduced.

### INVENTIVE EXAMPLE

Wood fibers (75% by weight), BiCo fibers (18% by weight, polyethylene terephthalate/polyethylene terephthalate-co-isophthalate), and 7% of flame retardant (ammonium polyphosphate and tris(tribromoneopentyl) phosphate) were conveyed from bale openers into a mixing device. The fibers were then re introduced uniformly in the desired mixing ratio into a blowing line by way of separate weighing equipment downstream of the bale openers, and were supplied pneumatically via the blowing line to a holding vessel. The fiber mixture was blown from the holding vessel onto a first conveyor belt, with spatial orientation of the fibers. The resultant web was defibrated at the end of the first conveyor belt, and after further mixing, blown onto a second conveyor belt with spatial orientation of the fibers. The weight per unit area of the resultant mat was 4200 g/m². The advance rate of the second conveyor belt was about 6 m/min.

The mat was precompacted to a thickness of 10 mm at temperatures of up to 140° C. in a continuous-flow oven.

Directly downstream of the continuous-flow oven, the mat was compacted to a thickness of 2.5 mm at a production speed of 6 m/min in a twin-belt press. The oil temperature in the input section of the twin-belt press was 150° C.

Downstream of the twin-belt press for the compaction process there was a cooling press with water-cooling in which the solid-borne-sound underlay was cooled to about 15-40° C. Pieces with the required dimensions (800×675 mm in the form of sheets or 10 000×675 mm, subsequently rolled up) were then cut from the continuous web.

The improvement of the sound pressure level due to the use of the resultant solid-borne-sound underlay was moreover measured. The results of these measurements are summarized as follows:
+0.5 dB(A)—improvement perceptible only under good acoustic conditions;
+1.0 dB(A)—perceptible threshold for improvement;
+3.0 dB(A)—signal energy halved;
+6.0 dB(A)—sound pressure halved;
+10.0 dB(A)—subjective loudness halved.

For a thickness of 2.5 mm, the solid-borne-sound underlay achieved an improvement of ΔLw=17 dB in solid-borne-sound.

1. A solid-borne-sound underlay based on a wood-plastics-composite material.

2. The solid-borne-sound underlay as claimed in claim 1, wherein the plastic takes the form of a thermoplastic, in particular takes the form of thermoplastic granules or synthetic fibers

3. The solid-borne-sound underlay as claimed in claim 1, wherein the plastic takes the form of bicomponent fibers.

4. The solid-borne-sound underlay as claimed in claim 3, wherein the plastic takes the form of bicomponent fibers based on polyethylene (PE).

5. The solid-borne-sound underlay as claimed in claim 1, wherein the plastic takes the form of a thermoplastic or plastics mixture, selected from the group comprising polyethylene (PE), polypropylene (PP), polyvinyl chloride (PVC), polyester, and polyethylene terephthalate

6. The solid-borne-sound underlay as claimed in claim 1, wherein the wood-particle-plastics mixture comprises a ratio between 90% by weight of wood particles/10% by weight of plastic and 20% by weight of wood particles/80% by weight of plastic, preferably between 70% by weight of wood particles/30% by weight of plastic and 40% by weight of wood particles/60% by weight of plastic.

7. The solid-borne-sound underlay as claimed in claim 1, wherein the proportion of wood fibers is 75% by weight.

8. The solid-borne-sound underlay as claimed in claim 1, wherein the proportion of plastic is 18% by weight.

9. The solid-borne-sound underlay as claimed in claim 1, wherein the solid-borne-sound underlay moreover comprises between 5 and 10% by weight, preferably between 6 and 8% by weight, with particular preference 7% by weight, of at least one flame retardant.

10. The solid-borne-sound underlay as claimed in claim 9, wherein the at least one flame retardant is selected from the group comprising nitrogen, phosphates, borates, in particular ammonium polyphosphate, tris(tribromoneopentyl) phosphate, zinc borate, and boric acid complexes of polyhydric alcohols.

11. The solid-borne-sound underlay as claimed in claim 1, wherein the thickness of the solid-borne-sound underlay is between 2 and 15 mm, preferably 2 and 9 mm, with particular preference 2.5 mm.

12. The solid-borne-sound underlay as claimed in claim 1, wherein the 10 envelope density of the solid-borne-sound underlay is between 200 and 400 kg/m³, preferably between 220 and 300 kg/m³, with particular preference 260 kg/m³.

13. The solid-borne-sound underlay as claimed in claim 1, wherein the fibers used have three-dimensional orientation.

14. The solid-borne-sound underlay as claimed in claim 1, wherein the solid-borne-sound underlay has resilient properties.

15. The solid-borne-sound underlay as claimed in claim 1, wherein the solid-borne-sound underlay can be reversibly rolled up.

16. A process for the production of a solid-borne-sound underlay based on a wood-plastics-composite material, comprising the following steps:
application of a mixture of wood particles and plastic to a first conveyor belt with formation of a preliminary web and introduction of the preliminary web into at least one first continuous-flow oven for precompaction;
transfer of the precompacted preliminary web into at least one twin-belt press for further compaction to give a solid-borne-sound mat; and
cooling of the compacted solid-borne-sound mat in at least one cooling press.

17. The process as claimed in claim 16, wherein the preliminary web made of wood particles and plastic is precompacted in the at least one continuous-flow oven at temperatures between 125° C. and 150° C., preferably 135° C. and 140° C.

18. The process as claimed in claim 16, wherein the envelope density of the precompacted preliminary web after discharge from the conditioning oven is between 40 and 200 kg/m³, preferably 60 and 150 kg/m³, with particular preference between 80 and 120 kg/m³.

19. The process as claimed in claim 16, wherein the precompacted preliminary web is cooled and cut to size after it leaves the conditioning oven.

20. The process as claimed in claim 16, wherein the precompacted preliminary web is compacted in the at least one twin-belt press to a thickness between 2 mm and 15 mm, preferably 2 mm and 9 mm, with particular preference to 2.5 mm.

21. The process as claimed in claim 16, wherein the precompacted preliminary web is compacted in the at least one twin-belt press at temperatures between 140° C. and 200° C., preferably 140° C. and 180° C., with particular preference 140° C. and 160° C.

22. The process as claimed in claim 16, wherein the precompacted preliminary web is compacted in the at least one twin-belt press at a pressure between 2 MPa and 10 MPa, preferably 3 MPa and 8 MPa, with particular preference 5 and 7 MPa.

23. The process as claimed in claim 16, wherein the compacted solid-borne-sound underlay is cooled in the at least one cooling press to temperatures between 10 and 100° C., preferably 15 and 70° C., with particular preference 20 and 40° C.

24. The process as claimed in claim 16, wherein the compacted solid-borne-sound underlay is cooled in the at least one cooling press at a pressure which is identical, or at least almost identical, with the pressure in the twin-belt press.
